(19) United States
(12) Patent Application Publication
(10) Pub. No.: US 2026/0280884 A1
(43) Pub. Date: Sep. 17, 2026

(54) ELECTRONIC DEVICE FOR PROCESSING AUTHENTICATION FOR SECOND EVENT PROVIDED WHEN SUBSCRIBIING TO MEMBERSHIP FOR FIRST EVENT, AND OPERATING METHOD THEREFOR

(71) Applicant: CJ ENM CO., LTD., Seoul (KR)

(72) Inventors: Dong Min SHIN, Seoul (KR); Dong Hoon HONG, Seoul (KR); Si Eun CHOI, Seoul (KR); Young Ju OK, Seoul (KR)

(21) Appl. No.: 19/168,230

(22) PCT Filed: Apr. 3, 2024
(86) PCT No.: PCT/KR2024/004356

§ 371 Date: Sep. 23, 2025

(30) Foreign Application Priority Data
May 25, 2023 (KR) 10-2023-0067808

(51) Int. Cl. H04L 9/32; H04L 9/06

(52) U.S. Cl. CPC H04L 9/3226; H04L 9/0631

(57) ABSTRACT

Disclosed is an operating method for an electronic device for processing, on the basis of resource location identification information included in an authentication code obtained from a manager terminal, authentication for a second event selected by a user from one or more second events related to a first event.

### TECHNICAL FIELD

The present disclosure relates to an operating method for an electronic device, which manages a record and authenticates a second event on the basis of an authentication code corresponding to the second event provided to a user when subscribing to a membership for a first event.

### BACKGROUND ART

A user may subscribe to a membership related to a first event to reserve the first event in a prior reservation period which is earlier than a regular reservation period, and one or more second events may be provided as a benefit for the user who has subscribed to the membership. The user may, when using the second event, perform an authentication procedure based on an authentication code, and, when authentication is completed according to the authentication procedure, may use the second event, and, when the authentication is cancelled, may not use the second event. Therefore, required is a technology which may manage a record and process authentication for a second event provided when subscribing to a membership for a first event.

### DETAILED DESCRIPTION OF THE INVENTION

### Technical Goals

According to the present example embodiments, disclosed are an electronic device and an operating method therefor, which manage a record and authenticate a second event on the basis of an authentication code corresponding to the second event provided to a user when subscribing to a membership for a first event. The technical goals aimed by example embodiments of the present disclosure are not limited to the technical goals as described above, and other technical goals may be derived from the following example embodiments.

### Technical Solutions

According to a first example embodiment, an operating method for an electronic device includes identifying resource location identification information included in an authentication code obtained from a manager terminal, determining, based on at least one piece of encrypted information included in the resource location identification information, validity of information related to a second event that is selected by a user from one or more second events corresponding to a sub-event related to a first event, and processing authentication for the second event that is selected by the user based on the validity of the information related to the second event.

According to an example embodiment, the operating method may further include recording a log corresponding to authentication completion for the second event. The determining of the validity may include identifying whether the second event is used by the user based on the log, and determining validity for the second event based on whether the second event is used.

According to an example embodiment, the resource location identification information may include encrypted information with respect to identification information of the user, identification information on a membership paid by the user among one or more memberships related to the first event, identification information on the second event which is an authentication target, identification information on the first event, and information on an authentication valid time.

According to an example embodiment, the resource location identification information may be characterized by being valid during the authentication valid time after having been generated at a user terminal.

According to an example embodiment, the determining of the validity may include determining the validity of the information related to the second event that is selected by the user by decrypting at least one piece of encrypted information included in the resource location identification information.

According to an example embodiment, the one or more memberships may include a first membership of one or more levels to be applied for a period set to correspond to the first event provided in a first time.

According to an example embodiment, the period set to correspond to the first event may include a prior period that precedes a regular reservation period by a predetermined amount of time and during the prior period the first event is reservable.

According to an example embodiment, the prior period may be defined differently for each of the one or more levels.

According to an example embodiment, the operating method may further include identifying an authentication completion order of the user for the one or more second events, identifying matching between the authentication completion order and a predetermined order, and, in a case of the matching, upgrading a grade at which the user reserved the first event.

According to an example embodiment, the one or more memberships may include a second membership to be applied to a first event provided in a first time and a first event provided in a second time which is different from the first time.

According to an example embodiment, the second membership may be characterized by corresponding to a membership by which the first event is to be reserved earlier than a regular period during a prior period that is set to correspond to a highest level among one or more levels corresponding to a first membership.

According to an example embodiment, the operating method may further include when authentication of the user for the second event is completed, identifying a language set by the user, and providing translation service for a video related to the first event based on the language.

According to an example embodiment, the operating method may further include identifying a level set with respect to one or more non-released videos related to the first event, identifying a level of the first membership which is paid by the user among the one or more levels corresponding to the first membership, comparing a level set with respect to the non-released video to the level of the first membership paid by the user, and, among the one or more non-released videos, according to a result of the comparing, providing the non-released video corresponding to the level of the first membership to the user.

According to an example embodiment, the authentication code may be a code set to vary depending on each of the one or more second events. The resource location identification information included in the authentication code may be characterized by being constituted with a random number code of 64 bits or greater.

According to an example embodiment, the operating method may further include analyzing use history information which is authenticated for each of one or more users, and identifying at least one keyword corresponding to each of the one or more second events according to a result of the analyzing.

According to an example embodiment, the resource location identification information may include information obtained by serializing, as serialized data, identification information of the user, identification information on a membership paid by the user among one or more memberships related to the first event, identification information on a second event which is an authentication target, identification information on the first event, and information on an authentication valid time and then encrypting the serialized data using an advanced encryption standard-128 (AES-128) algorithm.

According to an example embodiment, the determining of the validity may include decrypting, based on a key value used in an encrypting process of the resource location identification information, the encrypted information included in the resource location identification information to determine the validity of the information related to the second event.

According to an example embodiment, the authentication code displayed on the user terminal may be characterized by being displayed along with tag information related to the one or more second events corresponding to the membership paid by the user.

According to an example embodiment, the identification information on the membership paid by the user may be characterized by being provided to an external server by which the first event is to be reserved in order for the first event to be reserved during the prior period.

According to a second example embodiment, an electronic device includes a communication device, a memory, and a controller which is configured to identify resource location identification information included in an authentication code obtained from a manager terminal, determine, based on at least one piece of encrypted information included in the resource location identification information, validity of information related to a second event selected by a user from one or more second events corresponding to a sub-event related to a first event, and process, based on the validity of the information related to the second event, authentication for the second event selected by the user.

According to a third example embodiment, a computer-readable recording medium includes a non-transitory recording medium having a program for executing the above-described operating method on a computer.

Specific details of other example embodiments are included in detailed descriptions and drawings.

### Effects of the Invention

According to the example embodiments, it is possible to authenticate whether a second event is available on the basis of an authentication code corresponding to the second event that is provided to a user when the user subscribes to a membership related to a first event. Here, resource location identification information included in the authentication code includes a random number code of 64 bits or greater to avoid inference, and may be re-generated after a predetermined time has passed after having been generated. Further, in order to protect personal information, identification information on a membership which is not information related to identification information of the user may be provided to an external server, and the external server may compare the provided information to membership list information received by an electronic device to perform a ticket reservation procedure with respect to the user. Further, a log related to authentication processing may be recorded and managed, and, on the basis thereof, whether there has been previous use may be identified. Here, use history information for each user may be analyzed to be evaluated for each second event, and, by reflecting a result of the evaluating, a second event corresponding to a first event provided in a different time may be organized.

The effects to be obtained in the present disclosure are not limited to the aforementioned effects, and other effects not mentioned herein will be clearly understood by those skilled in the art from the description of claims.

### BRIEF DESCRIPTION OF DRAWINGS

FIG. 1 illustrates a system according to an example embodiment.

FIG. 2 is a diagram for describing a process of generating an authentication code at a user terminal according to an example embodiment.

FIG. 3 is a diagram for describing an authentication process at a manager terminal according to an example embodiment.

FIG. 4A to FIG. 4C are screens for describing information related to a first event and a second event displayed at a user terminal according to an example embodiment.

FIG. 5 is a drawing for describing an authentication completion order of a user for one or more second events according to an example embodiment.

FIG. 6 is a diagram for describing a non-released video which is available depending on a level of a membership according to an example embodiment.

FIG. 7 is a flowchart of an operating method for an electronic device according to an example embodiment.

FIG. 8 is a drawing illustrating a block diagram of an electronic device according to an example embodiment.

### MODE FOR CARRYING OUT THE INVENTION

Terms used in the example embodiments are selected from currently widely used general terms when possible while considering the functions in the present disclosure. However, the terms may vary depending on the intention or precedent of a person skilled in the art, the emergence of new technology, and the like. Further, in certain cases, there are also terms arbitrarily selected by the applicant, and in these cases, the meaning will be described in detail in the corresponding descriptions. Therefore, the terms used in the present disclosure should be defined based on the meaning of the terms and the contents of the entire present disclosure, rather than the simple names of the terms.

Throughout the specification, when a part is described as “comprising or including” a component, it does not exclude another component but may further include another component unless otherwise stated. Furthermore, terms such as “. . . unit” and “. . . module” described in the specification mean a unit that processes at least one function or operation, which may be implemented as hardware, software, or a combination thereof.

Expression “at least one of a, b and c” described throughout the specification may include “a alone,” “b alone,” “c alone,” “a and b,” “a and c,” “b and c,” or “all of a, b and c.”

A “terminal” referred to hereinafter may be implemented as, for example, a computer or a portable terminal capable of accessing a server or another terminal through a network. Here, the computer may include, for example, a notebook, a desktop computer, and/or a laptop computer which are equipped with a web browser. The portable terminal may be a wireless communication apparatus ensuring portability and mobility and include (but is not limited to) any type of handheld wireless communication apparatus, for example, a tablet PC, a smartphone, or a communication-based terminal such as international mobile telecommunication (IMT), code division multiple access (CDMA), W-code division multiple access (W-CDMA), and long term evolution (LTE).

In the following description, example embodiments of the present disclosure will be described in detail with reference to the accompanying drawings so that those skilled in the art to which the present disclosure pertains may easily implement the present disclosure. However, the present disclosure may be implemented in many different forms and is not limited to the example embodiments described herein.

Hereinafter, example embodiments of the present disclosure will be described in detail with reference to the drawings.

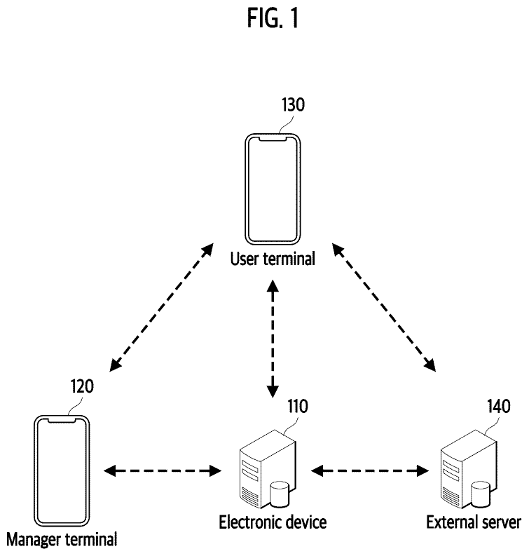

FIG. 1 illustrates a system according to an example embodiment.

Referring to FIG. 1, a system may include an electronic device 110, a manager terminal 120, a user terminal 130, and an external server 140. The electronic device 110 may process and manage one or more pieces of related information for authenticating an event. For instance, the electronic device 110 may manage information on at least one first event, at least one second event related to the first event, at least one membership related to the first event, and at least one user who has paid for a membership. In addition, the electronic device 110 may determine validity of information related to an event by decrypting encrypted information included in an authentication code, and specific details thereof will be described hereinafter.

Here, the first event may correspond to an event provided at a predetermined time such as a concert, for instance. A first event is an event which is provided at least once throughout a year, and so, each concert provided once in a quarter of a year may individually correspond to the first event, for example. A user may reserve a ticket by using the user terminal 130 during a regular reservation period during which a first event is to be reserved in order to participate in the first event.

Here, at least one membership related to the first event may be managed, and the user may pay for the membership to reserve a ticket by using the user terminal 130 during a prior period that precedes the regular reservation period by a predetermined amount of time. For instance, when a regular period during which a first event is to be reserved is set to a period from 2023.02.12. to 2023.02.24, a user who has paid for a membership may use the user terminal 130 to try to reserve a ticket during a period from 2023.02.05. to 2023.02.10, which is a prior period earlier than the regular period. By trying reservation of a ticket during the prior period, a user who has subscribed to the membership may have an increased possibility of reserving a ticket of a desired seat. Nevertheless, a desired seat is not guaranteed for a user who has subscribed to the membership, and an opportunity of trying reservation of a ticket in the prior period may be provided to increase possibility of reserving a desired seat.

A membership may be divided for each of one or more levels, and a prior period may be set to vary depending on the levels. For example, a membership may be divided into a first level, a second level and a third level of prices different from each other, and a user may select and pay for one level among the same. Here, a prior period set for each level is different, and thus the user may try reservation of a ticket during a prior period corresponding to a level for which payment is made. Here, the number of seats for each grade which may be reserved may be set to vary for each level, and thus the relatively higher level is paid for, the higher a possibility of reserving a seat of a desired grade may be.

A user who has paid for a membership may use at least one second event related to a first event. Here, the user may identify information on a membership subscribed by using the user terminal 130 and information on at least one second event. In the case of a second event which requires authentication, the user may suggest an authentication code generated in the user terminal 130, and a manager may scan the authentication code by using the manager terminal 120 to process whether to perform authentication. Specifically, the authentication code may include resource location identification information, and the manager terminal 120 may access a landing page corresponding to the resource location identification information by scanning the authentication code to process whether to perform authentication. Here, the resource location identification information may correspond to a uniform resource locator (URL), for instance. Here, the electronic device 110 may decrypt at least one piece of encrypted information included in the resource location identification information to check whether the same is valid, and may provide information of a result of the checking with respect to whether the same is valid on a landing page. The manager may log in to the landing page by using the manager terminal 120, and process authentication completion or authentication cancellation based on whether the same is valid. The electronic device 110 may be used when recording a second event authentication use log of a user, and then, checking whether the identical second event is used by the user. Further, the electronic device 110 may record information on authentication completion or authentication cancellation of the manager as a log.

The user may use the user terminal 130 to check identification information on the subscribed membership. A ticket reservation service with respect to a first event is a service provided from the external server 140 which is not the electronic device 110, and service may be provided by means of at least one external server 140 for each country. When the identification information on the membership is provided to the external server 140, the external server 140 may check whether the user has subscribed to the membership on the basis of membership list information received from the electronic device 110, and the user whose subscription is confirmed may reserve a ticket in advance by using the external server 140. Here, the identification information on the membership is a six-digit random number, for instance, and is information separated from identification information of the user, in order for personal information of the user to be protected.

The manager terminal 120 and the user terminal 130 illustrated in FIG. 1 are only examples, and the scope of the present disclosure is not limited thereto. Therefore, those skilled in the art associated with the present example embodiment may understand that other components in general use in addition to the components illustrated in FIG. 1 may be further included.

The electronic device 110, the manager terminal 120, the user terminal 130, and the external server 140 may communicate with each other in a network. The network may include a local area network (LAN), a wide area network (WAN), a value-added network (VAN), a mobile radio communication network, a satellite communication network, and a mutual combination thereof and be a comprehensive data communication network that allows each network constituent illustrated in FIG. 1 to communicate smoothly with each other and include wired Internet, wireless Internet, and a mobile wireless communication network. Wireless communication may include, for example, a wireless LAN (e.g., Wireless Fidelity (Wi-Fi)), Bluetooth, Bluetooth low energy, Zigbee, Wi-Fi Direct (WFD), ultra wideband (UWB), Infrared Data Association (IrDA), near field communication (NFC), or the like. However, it is not limited thereto.

Hereinafter, a detailed process of processing authentication in relation to a second event is described.

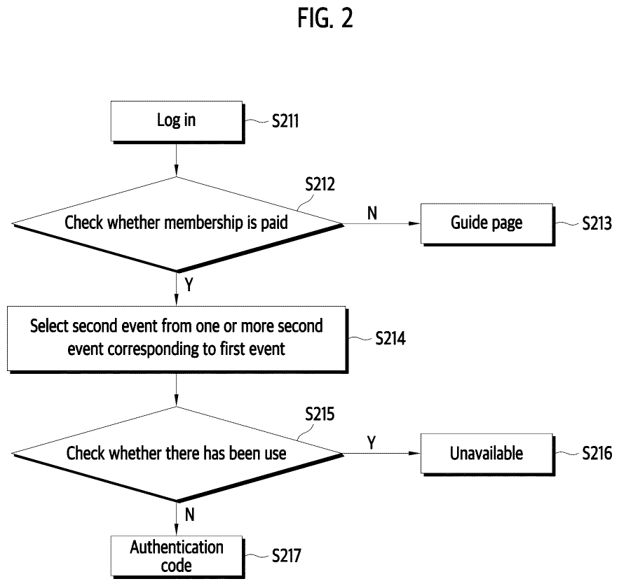

FIG. 2 is a diagram for describing a process of generating an authentication code at a user terminal according to an example embodiment.

Referring to FIG. 2, in operation S211, a user may log in to and access a page providing information related to a first event by means of a user terminal. Here, when the user is not a member who has subscribed to the page, a message for inducing member subscription may be displayed. Here, the page may be provided by means of an application.

In operation S212, whether or not a membership related to the first event is paid may be identified. When the user pays for the membership related to the first event, the user may reserve a ticket related to the first event during a prior reservation period which precedes a regular reservation period corresponding to the first event by a predetermined period, in order for the possibility of the user reserving a seat of a desired grade to increase.

When membership payment is not identified in operation S213, a guide page for guiding membership payment may be displayed. The user may select a purchase icon on the guide page to pay for the membership related to the first event.

A second event may be selected by the user from one or more second events corresponding to the first event in operation S214. In case payment with respect to the membership is identified, at least one second event along with information on the membership subscribed by the user may be displayed by means of a user terminal. The user may select a second event among one or more second events which are displayed.

In operation S215, whether the second event selected by the user is used may be identified, and, in case that there is a record that the same is previously used in operation S216, unavailability may be displayed, or, in case that there is no record that the same is previously used in operation S217, an authentication code may be displayed. Here, the authentication code may be displayed along with tag information related to at least one second event. Here, specific details regarding the tag information will be described hereinafter in another drawing.

The user may suggest the authentication code of the second event displayed on the user terminal to a manager. Here, the authentication code may include resource location identification information for authentication, and the resource location identification information may include encrypted information with respect to 1) identification information of the user, 2) identification information on the membership paid by the user among one or more memberships related to the first event, 3) identification information on a second event which is an authentication target, 4) identification information on the first event, and 5) information on an authentication valid time (for instance, 60 seconds). As for the information 1) to 5), the authentication code may include information such as, for example, (11, XRDD2N, 22, kconla 2023, 20230404145512), (25, KU3V3N, 110, kconla 2023, 20230404145721), (31, W23MB 5, 32, kconjapan 2023, 20230404145945), and the like.

Here, the resource location identification information may include information encrypted based on a method of obtaining structured information as serialized data and then encrypting the same using an AES-128(Advanced Encryption Standard-128) algorithm, for instance. The electronic device may manage a key value used in encryption, and may use the same in a decrypting process afterwards.

The resource location identification information included in the authentication code is valid only during an authentication valid time (for example, 60 seconds) after having been generated in the user terminal, and, after the 60 seconds, the authentication code and the resource location identification information may be re-generated. In addition, the resource location identification information constituted with a random number code of 64 bits or greater may be set to vary for each second event.

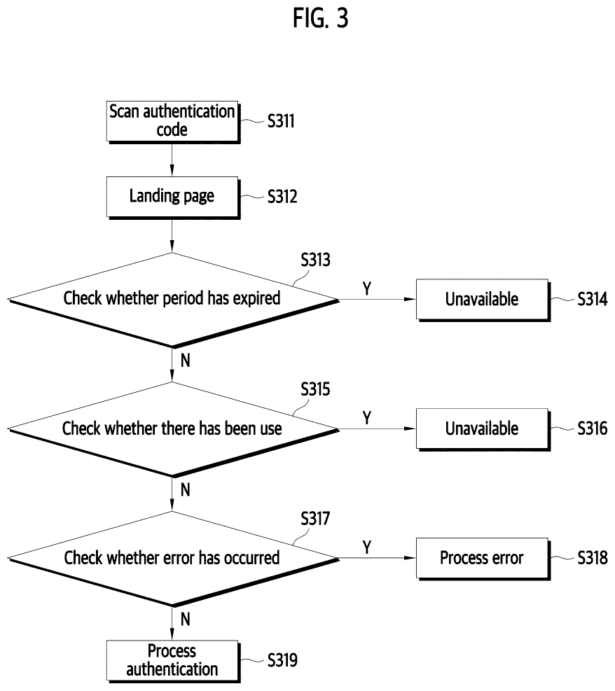

FIG. 3 is a diagram for describing an authentication process at a manager terminal according to an example embodiment.

Referring to FIG. 3, an authentication code displayed in a user terminal in operation S311 may be scanned by means of a manager terminal, and a landing page corresponding to resource location identification information included in the authentication code may be accessed in operation 312. By means of the electronic device, a manager that is approved in advance may log in to the landing page and process whether to perform authentication.

Encrypted information included in the resource location identification information may be decrypted by using a key value managed by the electronic device, and validity of pieces of information related to a second event such as 1) whether an authentication valid time has passed, 2) whether user identification information is valid, 3) whether membership identification information of a user and user identification information match, 4) whether membership identification information of a user is valid, 5) whether the second event is valid, and 6) whether the second event is available may be determined. Specifically, in operation S313, validity with respect to whether a period has expired may be checked. If the period has expired, a screen displaying ‘unavailable’ may be displayed in operation S314.

Or, if the period has not expired, along with information on a second event which is an authentication target and information on a membership, an authentication request page displaying an ‘authenticate’ icon may be displayed on the manager terminal, and the manager may select the ‘authenticate’ icon in the authentication request page to request authentication with the electronic device. Here, in operation S315, whether there has been previous use may be identified based on a log managed by the electronic device, and, in case that it is identified that there has been previous use, a screen displaying ‘unavailable’ may be displayed in operation S316.

In relation to operation S313 to operation S315 described in FIG. 3, the scope of the present disclosure is not limited to the above-described order, and, the case in which the same are simultaneously performed or performed in a changed order may also be included in the scope of the present disclosure.

Alternatively, in case that it is identified that there has been no use, whether an error has occurred during an authentication processing process with respect to the second event may be identified in operation S317. In case that an error has occurred, authentication may be cancelled due to processing the error in operation S318, and the manager may perform an authentication process again from the beginning. Alternatively, in case that an error has not occurred, authentication completion may be processed with respect to the second event which is an authentication target in operation S319.

In case that the authentication completion for the second event which is an authentication target is processed, the electronic device may record and manage a log corresponding to the authentication completion for the second event which is an authentication target, and afterwards in operation S315, based on the log, whether the second event is used may be identified.

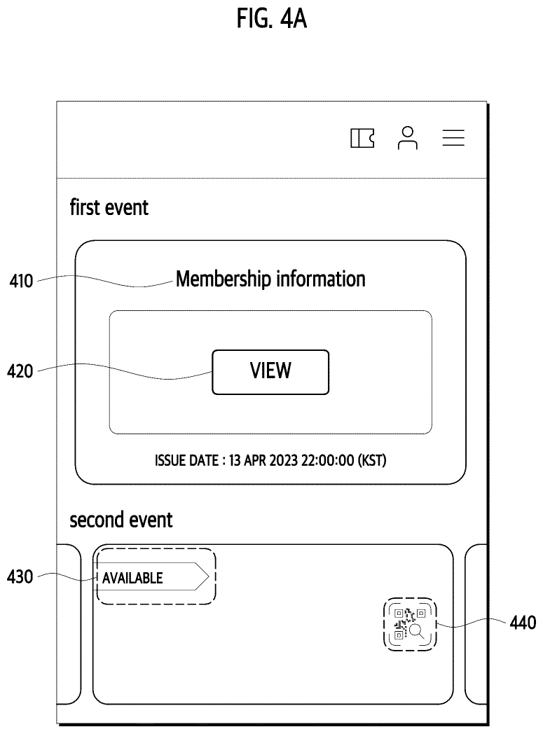

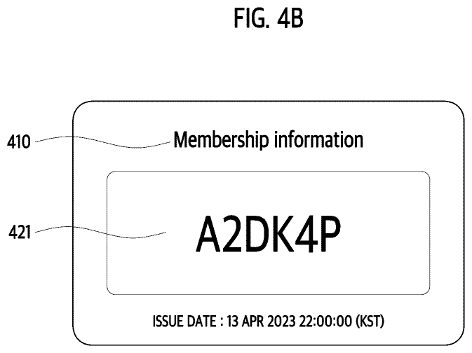

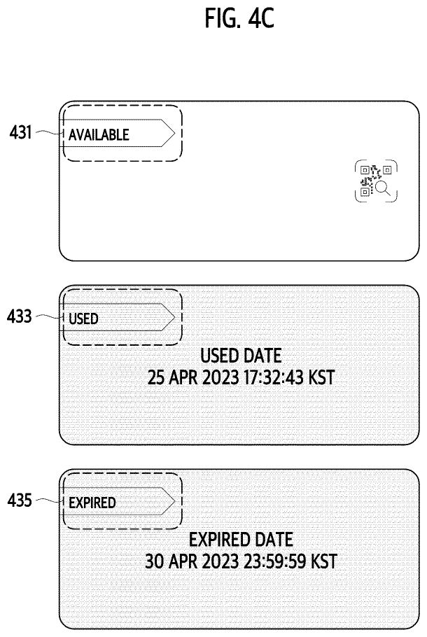

FIG. 4A to FIG. 4C are screens for describing information related to a first event and a second event displayed at a user terminal according to an example embodiment.

Referring to FIG. 4A, in case that a membership related to a first event is paid, a screen displayed on a user terminal may be identified. In an area 410, information of the membership related to the first event may be displayed, and, in an area 420, a ‘view’ icon may be displayed. When a user selects the ‘view’ icon, identification information 421 corresponding to the membership may be displayed as in FIG. 4B. Identification information on a membership may be constituted with a six-digit random number code for instance, and a user may input the identification information on the membership in an external server to reserve a ticket related to a first event. The external server may compare information received from the electronic device to the identification information on the membership provided by the user, in order to prevent personal information regarding the user from being exposed. Here, in the case of having succeeded in a ticket reservation procedure, the user may obtain a ticket from the external server.

Information on at least one second event related to a first event may be displayed as in FIG. 4A. Here, information on the plurality of second events may be displayed by using a predetermined method such as swiping in a left-and-right direction. For instance, information on the second event that varies depending on a left-and-right swiping method may be displayed in FIG. 4A.

As in FIG. 4A, tag information 430 related to a second event may be displayed along with an authentication code 440. For example, in a case of a second event which is available for the user, along with an ‘AVAILABLE’ tag 430, the authentication code 440 with respect to the second event may be displayed on a screen. If there has been previous use or the period thereof has expired, related information along with respectively corresponding tag information (for instance, ‘USED’ and ‘EXPIRED DATE’) may be displayed, but in this case, an authentication code may not be displayed together. Specifically, referring to FIG. 4C, an ‘AVAILABLE’ tag 431, a ‘USED’ tag 433, an ‘EXPIRED DATE’ tag 435 may be displayed, and, in case that the ‘USED’ tag 433 or the ‘EXPIRED DATE’ tag 435 is displayed, the same may be displayed by using a different color from that of the ‘AVAILABLE’ tag 431 in order to facilitate ease in identification. A second event corresponding to the ‘AVAILABLE’ tag 431 corresponds to an event which is available for the user, and a second event corresponding to the ‘USED’ tag 433 or the ‘EXPIRED DATE’ tag 435 may correspond to an event which is unavailable for the user.

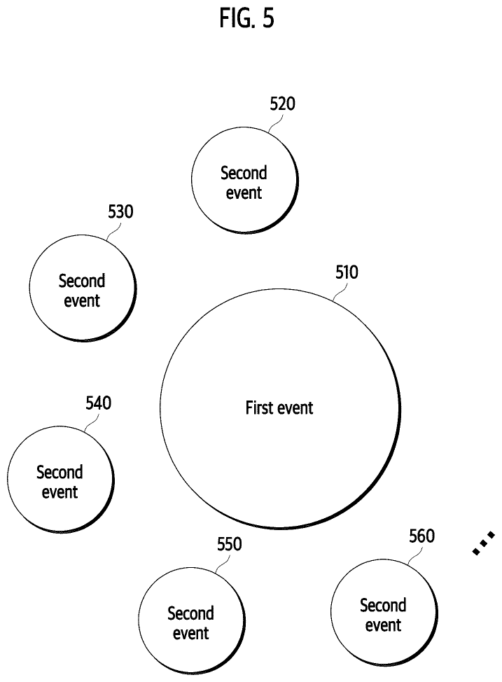

FIG. 5 is a drawing for describing an authentication completion order of a user for at least one second event according to an example embodiment.

Referring to FIG. 5, one or more second events (a second event 520, a second event 530, a second event 540, a second event 550, a second event 560 and the like) may be an event related to a first event 510. Here, each of the second events may be an event provided online or offline. For instance, on a site at which a concert, which is the first event 510, is provided, the one or more second events (the second event 520, the second event 530, the second event 540, the second event 550, the second event 560 and the like) may be provided offline as a sub-event related to the concert.

Here, a user who has paid for a membership related to the first event 510 may participate after authenticating the one or more second events (the second event 520, the second event 530, the second event 540, the second event 550, the second event 560 and the like). The electronic device may monitor an authentication completion order of the user, and may identify a predetermined order and whether the same match. Here, the predetermined order is predetermined based on participation of the user in the second event, and, when the user authenticates according to the predetermined order, a benefit may be provided to the user. Therefore, motivation with respect to membership payment may be imparted to the users, and profitability may be improved thereby. For instance, when the user authenticates according to the predetermined order, a grade of a seat at which the user has reserved the first event may be upgraded. Alternatively, some seats among seats related to the first event 510 may be seats which are unable to be reserved, and may be seats provided only to the users who have authenticated according to the predetermined order.

Here, a clue related to the predetermined order may be provided by means of a channel by which an artist may communicate with the user. For instance, a clue related to the predetermined order may be provided based on a chatting platform used by an artist and a user. In other words, the electronic device may transmit a message related to a clue to the users who have subscribed to the membership related to the first event 510 by means of a chatting platform. Here, the chatting platform is a platform in which an artist and a user chat by 1:N, and a message written by an artist may be transmitted to a plurality of users. Therefore, the user who has received the message by means of the chatting platform may infer a clue to determine a participation order of the second event. By means of this, subscription of users to a chatting platform may be induced.

The one or more second events (the second event 520, the second event 530, the second event 540, the second event 550, the second event 560 and the like) are events different from each other, which are distinguished from each other, and the electronic device may analyze information on the users who have authenticated. In other words, the electronic device may analyze use history information which is authenticated for each user, and may extract at least one keyword corresponding to each second event according to a result of the analyzing.

Each second event is an event organized with a predetermined purpose (in other words, keyword), and, on the basis of at least one keyword corresponding to each second event, a degree of proximity to the predetermined keyword may be evaluated. Here, based on a model which has machine-learned by applying a predetermined method, similarity between the predetermined purpose (keyword) and the at least one keyword may be evaluated, and a purpose achieving degree may be evaluated and managed based thereon. More specifically, by using a database which is managed by having an arbitrary word and similar words corresponding thereto as a group, information of the similarity between the at least one keyword corresponding to each second event and the predetermined keyword may be calculated by means of the predetermined method. Here, a value corresponding to the purpose achieving degree may be outputted by reflecting a result of the calculating, and based on the outputted value, the purpose achieving degree may be evaluated and managed. In addition, various methods may be applied in related technological fields in relation to a method for measuring similarity between keywords.

Alternatively, use history information may be analyzed for each of a user with a record of having previously subscribed to the membership for the first event 510 and a new user without a record of having previously subscribed to the membership for the first event 510 in order to extract at least one keyword for each user. Similarity between a keyword which is extracted for each of the user with the record of having previously subscribed and the new user and the predetermined purpose may be individually evaluated. The purpose achieving degree may be reflected in a process of organizing a second event provided when the first event is held again afterwards.

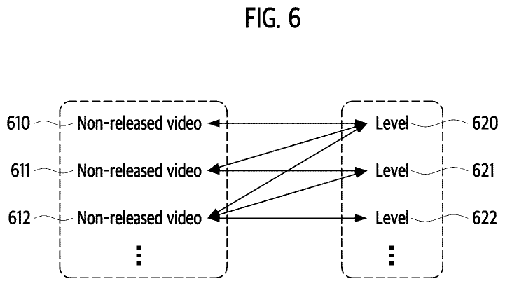

FIG. 6 is a diagram for describing a non-released video which is available depending on a level of a membership according to an example embodiment.

Referring to FIG. 6, a non-released video may be an unreleased video in which an artist is photographed in relation to a first event. The non-released video may be provided to a user who has subscribed to at least one membership related to the first event.

Here, a level may be set in advance in relation to the non-released video, and may be compared to a level of a membership. Specifically, a level set with respect to the non-released video and a level of the membership may be compared, and, according to a result of the comparing, the non-released video may be provided to a user who has subscribed to the level of the corresponding membership. For instance, as for a non-released video 610, a level may be set in advance, and may be provided to a user who has subscribed to a corresponding level 620 of a membership. Alternatively, as for a non-released video 611, a level may be set in advance, and may be provided to a user who has subscribed to a corresponding level 621 of the membership and the upper level 620 thereof. Alternatively, as for a non-released video 612, a level may be set in advance, and may be provided to a user who has subscribed to a corresponding level 622 of the membership and the upper level 620 and the upper level 621 thereof. Therefore, users may be induced to subscribe to a membership of a higher level.

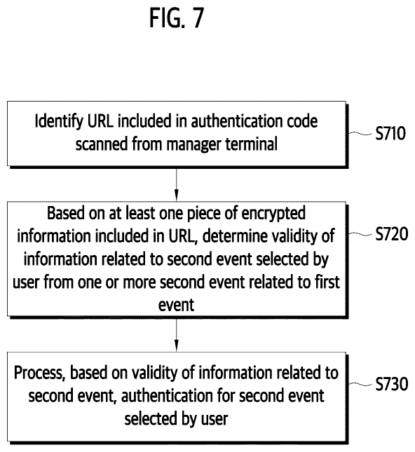

FIG. 7 is a flowchart of an operating method for an electronic device according to an example embodiment.

Referring to FIG. 7, in operation S710, the electronic device may identify resource location identification information included in an authentication code obtained from a manager terminal. Here, the manager terminal may scan the authentication code of a user terminal to obtain related information. Here, the authentication code is a code set to vary depending on each of one or more second events, and the resource location identification information included in the authentication code may be constituted with a random number code of 64 bits or greater. For instance, an authentication code including resource location identification information constituted with a random number code of 64 bits or greater for each of second events that are different from each other may be set.

In case that the authentication code generated in the user terminal is suggested, the manager terminal may scan the authentication code, and, based on the resource location identification information included in the authentication code, may land on an authentication page. The manager terminal may log in to the authentication page, and the electronic device may process whether to perform authentication by decrypting at least one piece of encrypted information included in the resource location identification information by means of the authentication page.

Here, the resource location identification information may include identification information of a user, identification information on a membership paid by the user among one or more memberships related to a first event, identification information on a second event which is an authentication target, identification information on a first event, and encrypted information on an authentication valid time. The resource location identification information may include other various kinds of information to be used during an authentication process. Here, the resource location identification information may be valid during the authentication valid time after having been generated at the user terminal, and may be automatically re-generated afterwards.

Here, the resource location identification information may include information encrypted based on a method of obtaining structured information as serialized data and then encrypting the same using an Advanced Encryption Standard-128(AES-128) algorithm, for instance. The electronic device may manage a key value used in an encrypting process, and may use the same in a process of decrypting the encrypted information included in the resource location identification information afterwards.

In addition, the authentication code displayed on the user terminal may be displayed along with tag information related to at least one second event corresponding to the membership paid by the user. Here, as for the specific details related to the tag information, the above-mentioned descriptions will be referred to.

One or more memberships related to a first event include a first membership of at least one level which may be applied for a period set to correspond to the first event provided in a first time. The first event may be held by several times, and a membership may be subscribed for each first event. In such a case, the membership corresponding to the first event may be applied for the set period, and may be divided into a plurality of levels. Here, the period set to correspond to the first event may include a prior period that precedes a regular reservation period by a predetermined amount of time and during the prior period the first event is reservable, and may be set as a period varying for each level. Alternatively, the first event may be held by several times, for example, the first event provided in the first time and the second event provided in a second time. Here, the one or more memberships may include a second membership to be applied to the first event provided not only in the first time but also in the second time. The second membership may correspond to a membership by which the first event is to be reserved earlier than the regular period during the prior period which is set to correspond to a highest level among one or more levels corresponding to the first membership.

According to an example embodiment, reservation related to the first event may be performed in an external server other than the electronic device. Therefore, the user may input identification information on a paid membership to the external server by which the first event may be reserved. Here, the external server may identify whether the identification information inputted by the user matches based on related information received from the electronic device, and, in a case of the matching, the user may reserve a seat related to the first event by means of the external server. For instance, in case that the first event is held in a foreign country, the user may input the identification information on the membership in a foreign server to perform reservation of a seat related to the first event.

In operation S720, the electronic device may determine, based on at least one piece of encrypted information included in the resource location identification information, validity of information related to a second event selected by the user from one or more second events related to the first event. In other words, the electronic device may determine the validity of the information related to the second event selected by the user by decrypting the at least one piece of encrypted information included in the resource location identification information.

In relation to the first event, at least one second event may be provided. The second event may include an event provided offline or an event provided online. For instance, translation service for each country with respect to a remote concert, a priority entrance benefit in relation to the first event, preoccupying a preferred seat in relation to the first event, providing an item related to the first event, tracking an authentication order participating in the second event, an advance reservation at a fan meeting, and preoccupying a preferred seat may be included in the second event.

The electronic device may determine validity by decrypting the resource location identification information which is identified by scanning the authentication code at the manager terminal before checking 1) whether the authentication valid time has passed, 2) whether user identification information is valid, 3) whether the identification information on the membership of the user and the identification information of the user match, 4) whether the identification information on the membership of the user is valid, 5) whether the membership and the second event are valid, and 6) whether the user has previously used the second event. In addition, the electronic device may decrypt the resource location identification information to check various kinds of information in order to determine the validity. For instance, the electronic device may, when authentication is completed for the second event, based on a recorded log, check whether the second event is previously used and determine validity for the second event on the basis thereof.

According to an example embodiment, the electronic device may check a level of the first membership paid by the user, and may check a level set with respect to the second event selected by the user. The second event may be set at levels different from each other, and participation may be limited depending on a level of the membership. Therefore, whether a level of the first membership corresponds to a level set with respect to the second event may be identified, and, in case that the same corresponds to the level, the validity of the information related to the second event may be determined. If the same does not correspond to the level, the information related to the second event is determined as invalid, leading to cancellation of authentication.

In operation S730, the electronic device may process authentication for the second event selected by the user based on the validity of the information related to the second event. After then, a log corresponding to authentication completion for the second event may be recorded, and the electronic device may identify whether the user has used the second event based on the log, and determine, based on whether the second event is previously used, the validity for the second event to process authentication.

According to an example embodiment, when the authentication of the user for the second event is completed, the user may participate in the second event. The electronic device may analyze use history information which is authenticated for each user, and may identify matching between an authentication completion order and a predetermined order, and, in a case of the matching, upgrade a grade at which the user reserved the first event. If the number of matching users is greater than the number of seats of which the reserved grade may be upgraded, the electronic device may select the users according to a predetermined standard. Specifically, the plurality of users may be aligned based on a level of the membership paid by the user, the number of times by which the user has previously participated in the first event, and whether the user has won an upgrade event, and the users selected according to an aligned order may be selected for an upgrade of a grade.

According to an example embodiment, the use history information which is authenticated for each of the one or more users may be analyzed, and at least one keyword corresponding to each of the one or more second events according to a result of the analyzing may be identified. Here, the second event has a predetermined purpose, and similarity between the predetermined purpose and at least one keyword may be compared in order for a purpose achieving degree to be evaluated. After then, the purpose achieving degree may be reflected in an organization step of the second event.

According to an example embodiment, in case that the second event is translation service for each country for a remote concert, when the authentication of the user for the second event is completed, a language set by the user may be identified, and the translation service may be provided for a video related to the first event based on the language. Here, in case that a predetermined word (for example, you, fans, and the like) referring to a fan is identified during a process in which the translation service is provided, service may be provided to translate by changing the predetermined word into a nickname set by the user based on a level of the membership. For example, in case that an artist refers to the predetermined word during a process of the first event, the user who has subscribed to the membership of a highest level may be provided with the translation service by which the predetermined word is changed into the nickname set by the user. Therefore, satisfaction of the user may be further improved.

According to an example embodiment, the electronic device may identify a level set with respect to at least one non-released video related to the first event, and may identify a level of the first membership paid by the user among one or more levels corresponding to the first membership. There are non-released videos related to the first event, and the non-released videos may be provided in a differential manner based on a level of the users who have subscribed to the first membership. Specifically, the electronic device may compare a level set with respect to the non-released video to a level of the first membership paid by the user, and, according to a result of the comparing, provide the non-released video corresponding to the level of the first membership to the user.

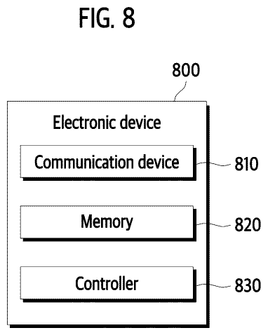

FIG. 8 is a drawing illustrating a block diagram of an electronic device according to an example embodiment.

According to an example embodiment, an electronic device 800 includes a communication device 810, a memory 820, and a controller 830. With respect to the electronic device 800 which is illustrated in FIG. 8, only components associated with the present example embodiment are illustrated. Therefore, those skilled in the art associated with the present example embodiment may understand that other components in general use in addition to the components illustrated in FIG. 8 may be further included. The electronic device 800 is the above-described electronic device, and duplicate descriptions will be omitted.

The communication device 810 may transmit and receive related information to and from a user terminal and a manager terminal by means of a network. The controller 830 may control an overall operation of the electronic device 800 and process data and a signal. The controller 830 may be constituted with at least one hardware unit. In addition, the controller 830 may be operated by one or more software modules generated by executing a program code stored in the memory 820. The controller 830 may control the overall operation of the electronic device 800 and process data and signals by executing the program code stored in the memory 820. Further, in an example embodiment, the controller 830 may include one or more processors.

The controller 830 may be configured to identify resource location identification information included in an authentication code obtained by the manager terminal, determine, based on at least one piece of encrypted information included in the resource location identification information, validity of information related to the second event selected by a user from one or more second events related to a first event, and process, based on the validity of the information related to the second event, authentication for the second event selected by the user.

The electronic device or terminal according to the above-described example embodiments may include a processor, a memory for storing and executing program data, a permanent storage such as a disk drive, and/or an interface device such as a communication port, a touch panel, a key and/or a button that communicates with an external device. Methods implemented as software modules or algorithms are computer-readable codes or program instructions executable on the control unit, and may be stored on a computer-readable recording medium. Here, the computer-readable recording medium may include a magnetic storage medium (e.g., a read-only memory (ROM), a random-access memory (RAM), a floppy disk, a hard disk, or the like), an optical reading medium (e.g., a CD-ROM or a digital versatile disc (DVD)), or the like. The computer-readable recording medium may be dispersed to computer systems connected by a network in order for computer-readable codes to be stored and executed in a dispersed manner. The medium may be read by a computer, stored in the memory, and executed by the processor.

The present example embodiments may be represented by functional block configurations and various processing steps. These functional blocks may be implemented by various numbers of hardware and/or software configurations that execute specific functions. For example, the example embodiments may adopt integrated circuit configurations such as a memory, a processor, a logic circuit, and a look-up table that may execute various functions by control of one or more microprocessors or other control devices. Similar to that components may be executed by software programming or software elements, the present example embodiments may be implemented by programming or scripting languages such as C, C++, Java, and assembler language, including various algorithms implemented by combinations of data structures, processes, routines, or of other programming configurations. Functional aspects may be implemented by algorithms executed by one or more processors. In addition, the present example embodiments may adopt the related art for electronic environment setting, signal processing, and/or data processing. The terms “mechanism”, “element”, “means”, and “configuration” may be widely used and are not limited to mechanical and physical configurations. The terms may include the meaning of a series of routines of software in association with a processor or the like.

The above-described example embodiments are merely examples, and other example embodiments may be implemented within the scope of the claims to be described later.

1. An operating method of an electronic device, the operating method comprising:
identifying resource location identification information included in an authentication code obtained from a manager terminal;
determining, based on at least one piece of encrypted information included in the resource location identification information, validity of information related to a second event that is selected by a user from one or more second events corresponding to a sub-event related to a first event; and
processing authentication for the second event that is selected by the user based on the validity of the information related to the second event.

2. The operating method of the electronic device of claim 1, further comprising recording a log corresponding to authentication completion for the second event,
wherein the determining of the validity comprises:
identifying whether the second event is used by the user based on the log; and
determining validity for the second event based on whether the second event is used.

3. The operating method of the electronic device of claim 1,
wherein the resource location identification information comprises encrypted information with respect to identification information of the user, identification information on a membership paid by the user among one or more memberships related to the first event, identification information on the second event which is an authentication target, identification information on the first event, and information on an authentication valid time.

4. The operating method of the electronic device of claim 3, wherein the resource location identification information is characterized by being valid during the authentication valid time after having been generated at a user terminal.

5. The operating method of the electronic device of claim 4,
wherein the determining of the validity comprises determining the validity of the information related to the second event that is selected by the user by decrypting at least one piece of encrypted information included in the resource location identification information.

6. The operating method of the electronic device of claim 3,
wherein the one or more memberships comprise a first membership of one or more levels to be applied for a period set to correspond to the first event provided in a first time.

7. The operating method of the electronic device of claim 6,
wherein the period set to correspond to the first event comprises a prior period that precedes a regular reservation period by a predetermined amount of time and during the prior period the first event is reservable.

8. The operating method of the electronic device of claim 7,
wherein the prior period is defined differently for each of the one or more levels.

9. The operating method of the electronic device of claim 1, further comprising:
identifying an authentication completion order of the user for the one or more second events;
identifying matching between the authentication completion order and a predetermined order; and
in a case of the matching, upgrading a grade at which the user reserved the first event.

10. The operating method of the electronic device of claim 3,
wherein the one or more memberships comprise a second membership to be applied to a first event provided in a first time and a first event provided in a second time which is different from the first time.

11. The operating method of the electronic device of claim 10,
wherein the second membership is characterized by corresponding to a membership by which the first event is to be reserved earlier than a regular period during a prior period that is set to correspond to a highest level among one or more levels corresponding to a first membership.

12. The operating method of the electronic device of claim 1, further comprising:
when authentication of the user for the second event is completed, identifying a language set by the user; and
providing translation service for a video related to the first event based on the language.

13. The operating method of the electronic device of claim 8, further comprising:
identifying a level set with respect to one or more non-released videos related to the first event;
identifying a level of the first membership which is paid by the user among the one or more levels corresponding to the first membership;
comparing a level set with respect to the non-released video to the level of the first membership paid by the user; and
among the one or more non-released videos, according to a result of the comparing, providing the non-released video corresponding to the level of the first membership to the user.

14. The operating method of the electronic device of claim 1,
wherein the authentication code is a code set to vary depending on each of the one or more second events, and
wherein the resource location identification information included in the authentication code is characterized by being constituted with a random number code of 64 bits or greater.

15. The operating method of the electronic device of claim 1, further comprising:
analyzing use history information which is authenticated for each of one or more users; and
identifying at least one keyword corresponding to each of the one or more second events according to a result of the analyzing.

16. The operating method of the electronic device of claim 5,
wherein the resource location identification information comprises information obtained by serializing, as serialized data, identification information of the user, identification information on a membership paid by the user among one or more memberships related to the first event, identification information on a second event which is an authentication target, identification information on the first event, and information on an authentication valid time and then encrypting the serialized data using an advanced encryption standard-128 (AES-128) algorithm,
wherein the determining of the validity comprises decrypting, based on a key value used in an encrypting process of the resource location identification information, the encrypted information included in the resource location identification information to determine the validity of the information related to the second event.

17. The operating method of the electronic device of claim 16,
wherein the authentication code displayed on the user terminal is characterized by being displayed along with tag information related to the one or more second events corresponding to the membership paid by the user.

18. The operating method of the electronic device of claim 17,
wherein the identification information on the membership paid by the user is characterized by being provided to an external server by which the first event is to be reserved in order for the first event to be reserved during the prior period.

19. A non-transitory computer-readable recording medium having a program for executing the operating method of claim 1 on a computer.

20. An electronic device comprising:
a communication device;
a memory; and
a controller which is configured to identify resource location identification information included in an authentication code obtained from a manager terminal, determine, based on at least one piece of encrypted information included in the resource location identification information, validity of information related to a second event selected by a user from one or more second events corresponding to a sub-event related to a first event, and process, based on the validity of the information related to the second event, authentication for the second event selected by the user.
